(19) United States
(12) Patent Application Publication
(10) Pub. No.: US 2006/0022391 A1
(43) Pub. Date: Feb. 2, 2006

(54) Engine suspension cushion assembly

(76) Inventor: Qingxin Chen, Quanzhou City (CN)

Correspondence Address: COZEN O'CONNOR, P.C., 1900 MARKET STREET, PHILADELPHIA, PA, 19103-3508, US

(21) Appl. No.: 11/191,715

(22) Filed: Jul. 28, 2005

(30) Foreign Application Priority Data
Jul. 28, 2004 (CN) 200410071051.X

(51) Int. Cl. F16F 1/12

(52) U.S. Cl. 267/174

(57) ABSTRACT

An engine suspension cushion assembly that provides longer life, better dynamics perfomances, and easier manufacture process than existing suspension cushion assembly is provided. The invention is an assembly comprising several suspension cushion members, several baffles, one upper base plate, one lower base plate and several clamp platens. The suspension cushion members are mounted between the upper base plate and the lower base plate; one end of each spring clamp platen is attached to the base plates, the other end connects the bottom of the spring. The baffles are mounted on the four sides of the upper base plate and the lower base plate, each side has two baffles, and the total is eight.

### CROSS-REFERENCE TO RELATED APPLICATIONS

The present application claims priority under 35 U.S.C. § 119 to Chinese Patent Application No. 200410071051.X, filed on Jul. 28, 2004, the entirety of which is hereby incorporated by reference.

### FIELD OF INVENTION

The present invention relates generally to machine dynamic system suspension cushion assemblies, and specifically to the field of engine suspension cushion assembly for vehicles including watercraft, automobiles, trucks and locomotives and for mining mechanisms and the like.

### BACKGROUND OF THE INVENTION

In the existing technology, engine suspension cushion assemblies usually employ some type of rubber-cushions to reduce vibration. The rubber blocks are placed between the upper base plate and the lower base plate. Because rubber cushions generally exhibit a constant rate of compression or constant spring rate, they are capable of preventing vibration and keeping balance. Such assemblies are typically produced as follows:
a) First, the chemical materials are mixed together and heated/softened;
b) Second, the heated and softened rubber materials are injected into the space between the upper base plate and the lower base plate, and cooled.
c) Finally, the adhesion makes the base plates as a whole.

U.S. Pat. No. 4,817,973 discloses a vehicle suspension assembly. The suspension assembly or mechanism for a vehicle consists of a pair of suspension arms connected with steerable wheels of a vehicle. A suspension support member carries the suspension arms and is made up of a transverse member integrally connected with a pair of longitudinal members, one on each side of the vehicle. Rubber mounts hold the suspension support member onto the vehicle frame. Rubber mounts pivotally support the suspension arms on the support member. A steering gear mechanism contained in a housing is carried on reinforcing members that are easily removable connected at one end with the transverse member, and easily removable connected at their other ends with the longitudinal members. The housing is fixed to the reinforcing member and can be easily detached and repaired. The support member is rigidly reinforced.

U.S. Pat. No. 4,854,606 discloses a vehicle suspension assembly, the suspension assembly consisting of a bearing structure capable of being fixed to the chassis of a vehicle. The structure holds the composite leaf spring in position to the ends of which the wheel supports are fixed. The supports are connected to the structure by wishbones and shock absorbers. Different positions of the composite leaf spring, wishbones and shock absorbers are described.

U.S. Pat. No. 6,085,858 discloses a suspension assembly for automotive engine. In a suspension assembly for an automotive engine of a front-engine/front-drive vehicle and for supporting the engine to a frame by an engine mount, an arrangement position of the engine mount in the vehicle is in the range between a vertical plane including an inertia main axis in a rolling direction of the engine and a vertical plane including a centerline of a drive shaft. Then, the vertical plane including the inertia main shaft is not included in the range and the vertical plane including the centerline of the drive shaft is included in the range. Thus, the arrangement position of the engine mount may be set in consideration of all of the idle vibration property, the drivability and the degree of freedom of design.

Several problems exist in regard to the patents discussed above. For example, the adhesion capacity is not good because of the physical and chemical performance of the rubber material, so the upper base plate and the lower base plate are often apart when in use. Also, the dynamic performances are not optimal, including drawing and pressure stress, shearing stress and torsional stress. Further, the manufacturing process is complicated, working conditions are sub-optimal and the consumptive energy in producing the assemblies is excessive. Additionally, the rubber will, after long-term service, lose elasticity because of aging.

### SUMMARY OF THE INVENTION

The present invention solves above-mentioned problems and provides an engine suspension cushion assembly. The assembly provides longer life and better dynamic performance.

In some embodiments, the suspension cushion member comprises springs instead of the rubber blocks/cushions, and baffles are mounted around the engine suspension cushion assembly.

The slots are made in the interior aspect of the base plates; the slot diameter dimension is approximate to the spring's diameter dimension in order that the spring can be mounted in the slot. In some embodiments one or more spring clamp platens is welded on the edge of the each shallow slot in order to make the spring fixed.

The baffles are made of lightweight material and may be attached to the sides of the base plates. In some embodiments the attachment is via welding. The baffles on the sides of the upper base plate and the baffles on the sides of the lower base plate are staggered in the vertical plane so that the springs can move freely, and the baffles can keep dust, sand and other undesired materials out of the engine suspension cushion assembly.

In some embodiments, advantages of the present invention include, but are not limited to: (1) longer life; (2) better dynamics performance; (3) easier manufacturing process; (4) lower cost; (5) lower consumptive energy and (6) reduced pollution.

### BRIEF DESCRIPTION OF THE DRAWING

Other advantages of the present invention can be understood by reference to the following detailed description when considered in connection with the accompanying drawings wherein:

FIG. 1 is a section schematic drawing of an engine suspension cushion assembly and

FIG. 2 is a schematic drawing of an engine suspension cushion assembly.

The Figures make reference to the following components:
1—the suspension cushion members
2—the shallow slot
3—the upper base plate
4—the baffle
5—the lower base plate
6—the ostiole
7—the spring clamp platen

### DETAILED DESCRIPTION

The features and characteristics of the present invention, an engine suspension cushion assembly, are described in the drawings.

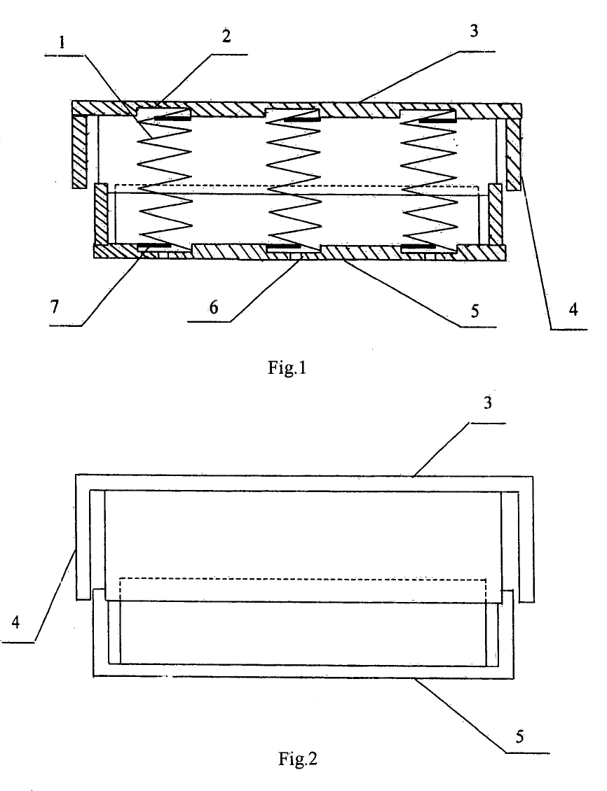

FIG. 1 is a section schematic drawing of an engine suspension cushion assembly. The suspension cushion unit comprises several suspension cushion members (1). Slots (2) are made in the upper base plate (3) and the lower base plate (5). The several suspension cushion members (1) are mounted in the slots (2). Spring clamp platens (7) are welded on the edge of the slot (2) in order to make the suspension cushion member (1) fixed. The spring clamp platen (7) is parallel to the edge of the slot (2), it fixes the suspension cushion member (1), the upper base plate (3) and the lower base plate (5) in a relative position and prevents the suspension cushion member (1) from sliding.

One or more ostioles (6) are located at or near the bottom of the slots (2) on the lower and/or upper base plate (5) in order to permit the escape of undesired materials including, but not limited to, sand, mud, rocks, and liquids. In some embodiments the ostioles also permit the dissipation of heat and ventilation of the suspension cushion assembly.

The present invention can also prevent or reduce loss of elasticity of the suspension cushion members (1) due to rust, corrosion, or the presence of undesired foreign particles.

FIG. 2 is a schematic drawing of an engine suspension cushion assembly. The baffles (4) are mounted on the four sides of the upper base plate (3), and the lower base plate (5). Each side has two or more baffles, and the total is at least eight. The baffles (4) are made of a lightweight material. The dimensions of the upper base plate (3) are bigger than the dimensions of the lower base plate (5). The baffles (4) on the sides of the upper base plate (3) and the baffles on the sides of the lower base plate (5) are staggered in the vertical plane so that the suspension cushion members can operate normally. The baffles (4) can keep undesired materials out of the engine suspension cushion assembly.

In some embodiments the suspension cushion members are air springs, helical springs, leaf springs, coil springs, hydraulic cylinders or the like. In some embodiments, the suspension cushion members are made of iron, steel, aluminum or other suitable material known to those skilled in the art.

In some embodiments, the upper base plate and the lower base plate each comprise one or more slots for engaging the suspension cushion members. In some embodiments the suspension cushion members are permanently affixed to the base plate at the slot. In some embodiments the slots are circular, semi-circular, oval, rectangular or square. In some preferred embodiments the slots are circular or semi-circular.

In some embodiments the slots are shallow. As used herein, the term “shallow” refers to the depth of the slot in relation to the thickness of the base plate. In some embodiments, the depth of the slots is less than 50%, less than 25%, less than 20%, less than 15%, less than 10%, or less than 5% of the thickness of the base plate.

While the invention has been described and illustrated in such detail that those skilled in this art can readily make and use, various alternatives, modifications, and improvements should become readily apparent without departing from the spirit and scope of the invention. All patent applications, patents and references cited herein are incorporated by reference in their entireties.

What is claimed is:

1. An engine suspension cushion assembly comprising an upper base plate (3), a lower base plate (5), and two or more suspension cushion members (1) connecting said upper base plate (3) and said lower base plate (5).

2. The cushion assembly of claim I wherein the suspension cushion members (1) are springs.

3. The cushion assembly of claim 2 wherein the springs are air springs, helical springs, leaf springs, or coil springs.

4. The engine suspension cushion assembly of claim 1 wherein the upper base plate (3) and the lower base plate (5) each include one or more slots (2).

5. The engine suspension cushion assembly of claim 1 wherein one or more spring clamp platen (7) is attached to the slot (2).

6. The engine suspension cushion assembly of claim 5 wherein the spring clamp platen is attached to the edge of the slot.

7. The engine suspension cushion assembly of claim 1 wherein one or more ostiole (6) is located at the bottom of each slot (2) on the lower base plate (5).

8. The engine suspension cushion assembly of claim 1 wherein two or more baffles (4) are mounted on the four sides of the upper base plate (3) and the lower base plate (5), and the dimension of the upper base plate (3) is larger than the dimension of the lower base plate (5).
